(19) United States
(12) Patent Application Publication
(10) Pub. No.: US 2015/0000107 A1
(43) Pub. Date: Jan. 1, 2015

(54) METHOD FOR MANUFACTURING HANDLES FOR CLEANING UTENSILS

(71) Applicant: SP BERNER PLASTIC GROUP, S.L., Aldaia (Valencia) (ES)

(72) Inventor: Julian ESCARPA GIL, Aldaia (Valencia) (ES)

(73) Assignee: SP BERNER PLASTIC GROUP, S.L., Aldaia (Valencia) (ES)

(21) Appl. No.: 14/252,954

(22) Filed: Apr. 15, 2014

Related U.S. Application Data
(63) Continuation of application No. PCT/ES2013/070427, filed on Jun. 26, 2013.

(51) Int. Cl. B23P 15/00

(52) U.S. Cl. CPC B23P 15/00
USPC 29/527.2

(57) ABSTRACT

The method begins with a metal strip deformed to form a tube, which outer face has been previously cleaned and conditioned to facilitate the adhesion of a first layer of adhesive material, on which a second layer of plastic material is applied and which is finally covered with a third layer, also of plastic material. The method used ensures the correct attachment of the different elements of the handle while providing a handle with a pleasant touch for the hands of the user. The handle obtained is more durable because it is perfectly protected against corrosion thanks to the three layers, each one of which is approximately 90 microns thick.

### OBJECT OF THE INVENTION

The present invention, as expressed in the wording of this specification, relates to a method for manufacturing handles for cleaning utensils, such as brooms, dust mops, mops, etc.

Basically, it is a method to put into practice the handle for cleaning utensils described in the invention patent identified with Spanish publication number ES 2225075, owned by the same holder of the present invention.

The method of the invention ensures a correct attachment of the different elements making up the handle, while providing a handle with a pleasant touch for the hands of the user.

### BACKGROUND OF THE INVENTION

Handles for cleaning utensils such as brooms, dust mops, mops and similar are currently known, among which we have those that comprise a metal tubular body which is covered on the outside by one or more coating layers of plastic material.

For example, invention patent identified with Spanish publication number ES 2225075 consists of a handle for cleaning utensils and similar having a base body providing the general shape of the handle, such that said base body is successively covered by a first layer of adhesive, a second layer of plastic material and a third layer also of plastic material. The third layer has a similar thickness and nature than the second layer.

The method for manufacturing this type of handles presents problems in the adhesion of the layer of adhesive or glue to the metal surface of the metal tubular body, which causes problems in the affixing of the subsequent layers of plastic material.

It has also been proven that the use of co-extrusion systems for the application of the different layers causes problems in the final result, which comes to a deficient adhesion among layers, an excessively matte finish and a lower-quality touch that is also unpleasant.

### DESCRIPTION OF THE INVENTION

With the purpose of achieving the objectives and avoiding the inconveniences mentioned in the previous sections, the invention proposes a method for manufacturing handles for cleaning utensils aimed at obtaining handles comprising a core formed by a metal tube covered by several surrounding layers of plastic material.

The method comprises the following steps:
Cleaning at least one outer face of a metal strip by means of the application of a degreasing product, eliminating the traces of cutting and coolant fluid and industrial oils inherent to the cutting and manufacturing processes of the metal strip.
Brushing the outer face of the metal strip to eliminate residue and condition its surface to achieve a better adhesion.
Deforming the metal strip to form an open tubular structure with two facing longitudinal edges close to each other.
Heating the longitudinal edges of the open tubular structure of the metal strip up to a welding temperature.
Closing completely the open tubular structure of the metal strip until the longitudinal edges touch each other, maintaining its welding temperature; a metal tube is formed in this step when the two longitudinal edges are attached by means of a welding generatrix.
Eliminating irregularities in the metal tube by means of a smoothing, grinding and hardening process.
Eliminating impurities, such as grease and slag, coming from the welding process, where the elimination of impurities is carried out through mechanical and friction processes, such as grinding wheels.
Heating the metal tube up to a temperature delimited between 125 and 150° C.
Applying a first layer of adhesive on the outer face of the metal tube at a hot temperature delimited between 225 and 230° C.
Applying a second layer of plastic material on the first layer of adhesive, also at a hot temperature delimited between 200 and 250° C.
Applying a third layer of plastic material on the second layer of plastic material with a hot temperature between 200 and 250° C.; where the fluidity of this third layer is greater than the fluidity of the second layer.
Cooling the set of the metal tube (2) with its three layers in a first cooling pond.
Cooling the set of the metal tube with its three layers in a second cooling pond after being in the first cooling pond; the temperature of the second cooling pond being lower than the temperature of the first cooling pond.
The temperature of the metal tube is kept hot during the application of the three layers: first, second and third.

The brushing of the outer face of the metal strip is carried out by means of a brushing device incorporating rotating brushes.

The deformation of the metal strip is carried out by means of a first rotating roller device.

The longitudinal edges of the open tubular structure of the metal strip are heated by means of a first induction device.

The formation of the metal tube is completed by means of a second rotating roller device.

Once formed, the elimination of the irregularities of the metal tube is carried out by means of laminating rollers for forming and by means of laminating rollers for grinding and alignment.

Once formed, the metal tube is heated by means of a second induction device.

The first layer of adhesive is a glue material.

The fluidity of the second layer of plastic material is delimited between 5 and 8 degrees in a preferred embodiment.

On the other hand, the fluidity of the third layer of plastic material is delimited between 55 and 65 degrees, also in a preferred embodiment.

The cooling temperature of the metal tube inside the first pond is delimited between 20 and 30° C., while the temperature of the second pond is delimited between 10 and 14° C.

The method of the invention comprises an optional intermediate step applied after the formation of the metal tube, which verifies the correct surface and structural finish of said metal tube by means of artificial vision devices.

The application of the layers: first, second and third, is carried out by means of a co-extrusion device where an inner space through which the metal tube advances is defined, the different coating layers of the handle being applied during the advance thereof.

In an embodiment of the invention, the second and third layers of plastic material are made of a polypropylene material from the polypropylene family.

Next, in order to facilitate a better comprehension of this specification and as an integral part thereof, figures representing the object of the invention in an illustrative rather than limitative manner have been attached.

### BRIEF DESCRIPTION OF THE DRAWINGS

FIG. 1. Shows a perspective view of a handle for cleaning utensils obtained by means of the method of the invention. The handle basically comprises a metal tube, covered by a first coating layer of adhesive, a second coating layer of plastic material and a third coating layer also of plastic material.

FIG. 2. Shows a perspective view of the metal strip from which each metal tube of the handle is obtained.

FIG. 3. Shows a view of a step of the manufacturing method wherein one of the faces of the metal strip is submitted to a cleaning process. Said face of the strip corresponds to an outer face of the metal tube, which is subsequently covered with the first layer of adhesive material.

FIG. 4. Shows a view of a step of the manufacturing method wherein one of the faces of the metal strip is submitted to a preparation process to improve the adhesion of the first layer of adhesive material.

FIGS. 5 to 8. Show different steps or steps of formation of the metal tube for the formation of the handle for cleaning utensils.

FIG. 9. Shows a view wherein the metal tube is heated up to an established temperature margin.

FIG. 10. Shows a view where the first layer of adhesive material and the two other layers of plastic material: second and third, are incorporated while hot.

FIG. 11. Shows a view where the set of the metal tube and the three concentric layers covering the same are submitted to a controlled cooling process.

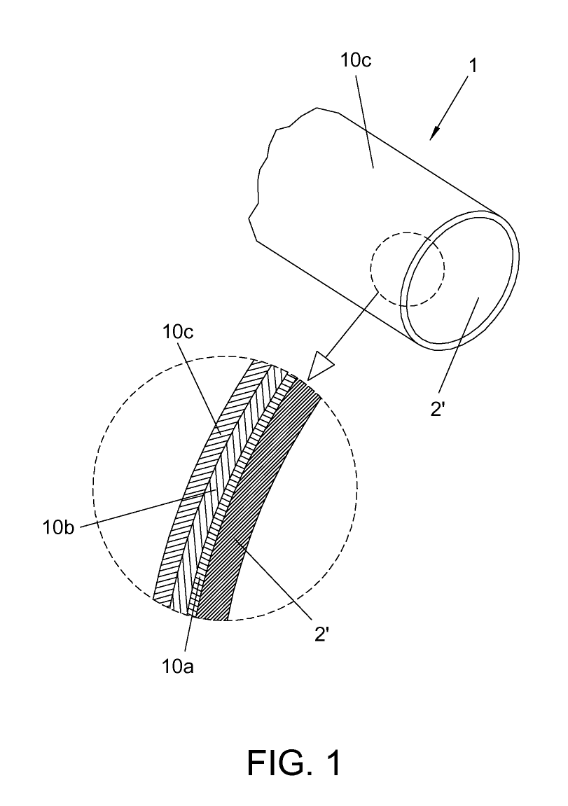

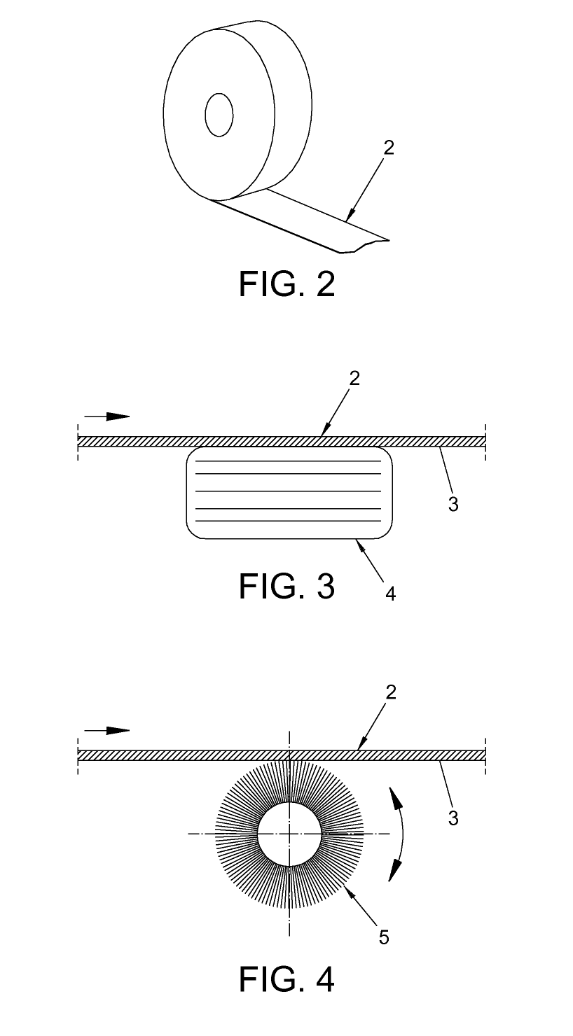

### DESCRIPTION OF THE PREFERRED EMBODIMENT

Taking into account the numbering adopted in the figures, the method for manufacturing handles for cleaning utensils contemplates the following nomenclature used in the description:
1.—Handle
2.—Metal strip
2′.—Metal tube
3.—Outer face
4.—Cleaning device
5.—Brushing device
6.—Longitudinal edges
6′.—Welding generatrix
7.—Laminating rollers for forming
8.—Laminating rollers for grinding and alignment
9.—First induction device
9′.—Second induction device
10.—Co-extrusion station
10a.—First layer
10b.—Second layer
10c.—Third layer
11.—First cooling pond
12.—Second cooling pond
13.—First rotating roller device
13′.—Second rotating roller device

The handle 1 to be obtained comprises a metal tube 2′, a first layer 10a of adhesive material, a second layer 10b of plastic material and a third layer 10c, also of plastic material.

Based on what was said in the previous paragraph, in order to obtain the handle 1 the method begins with a metal strip 2 made of laminated iron having a thickness comprised between 0.2 and 0.35 mm and a variable width, such that the tube 2′ is formed based on said metal strip 2 depending on the final diameter of the handle 1 to be obtained.

One face of the metal strip 2, to be referred to as the outer face 3, is subsequently submitted to a cleaning process by making the metal strip pass through a cleaning device 4 that applies a degreasing liquid or product, such that the traces of cutting and cooling fluid and industrial oils inherent to the cutting and manufacturing processes of the metal strip 2 are eliminated. The outer face 3 being cleaned corresponds to the outer face of the tube 2′ in contact with the first layer 10a of adhesive material.

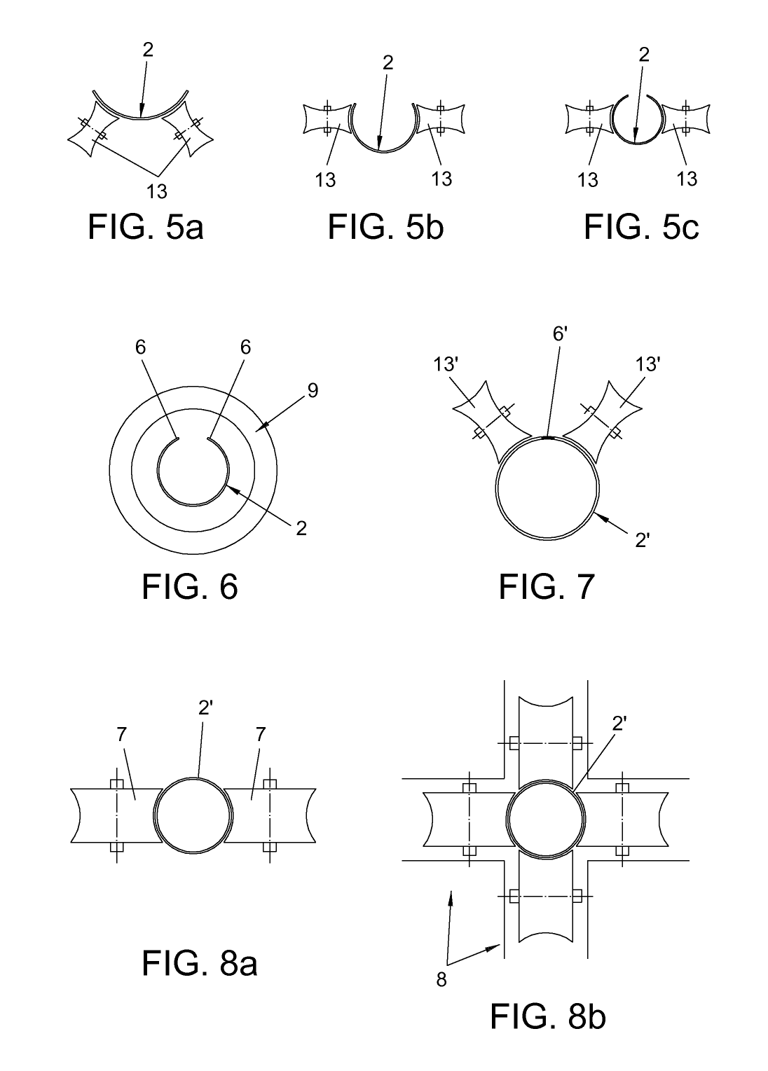

Next, the outer face 3 of the metal strip 2 is brushed by means of a rotating brushing device 5 incorporating metal teeth through which the residue is cleaned, and its surface is conditioned in order to achieve an improved adhesion of the first layer 10a of adhesive material. The metal strip 2 is then worked on by means of deformation with a first rotating roller device 13 to progressively form an unclosed tubular structure wherein facing longitudinal edges 6 are close to each other, as more clearly shown in FIG. 5c.

In the following step, shown in FIG. 6, the longitudinal edges 6 of the unclosed tubular structure of the metal tube 2′ are heated until a welding temperature is reached by means of a first induction device 9.

In the following step, shown in FIG. 7, the longitudinal edges 6 of the tubular structure of the unclosed metal tube 2′ are brought closer, maintaining the welding temperature to enable the connection by means of a welding generatrix 6′. The fully closed metal tube 2′ is formed in this step with the assistance of a second rotating roller device 13′ that brings closer the aforementioned longitudinal edges 6 of the tubular structure forming the metal tube 2′.

In another step (FIGS. 8a and 8b), the metal tube 2′ is submitted to different grinding processes to smooth and straighten the surface thereof, eliminating any irregularity generated in the previous steps. To achieve the foregoing, laminating rollers 7 for forming and laminating rollers 8 for grinding and alignment are used.

In this step or step, and in the successive steps, artificial vision devices are used with the purpose of verifying the correct surface finish and structure of the metal tube 2′.

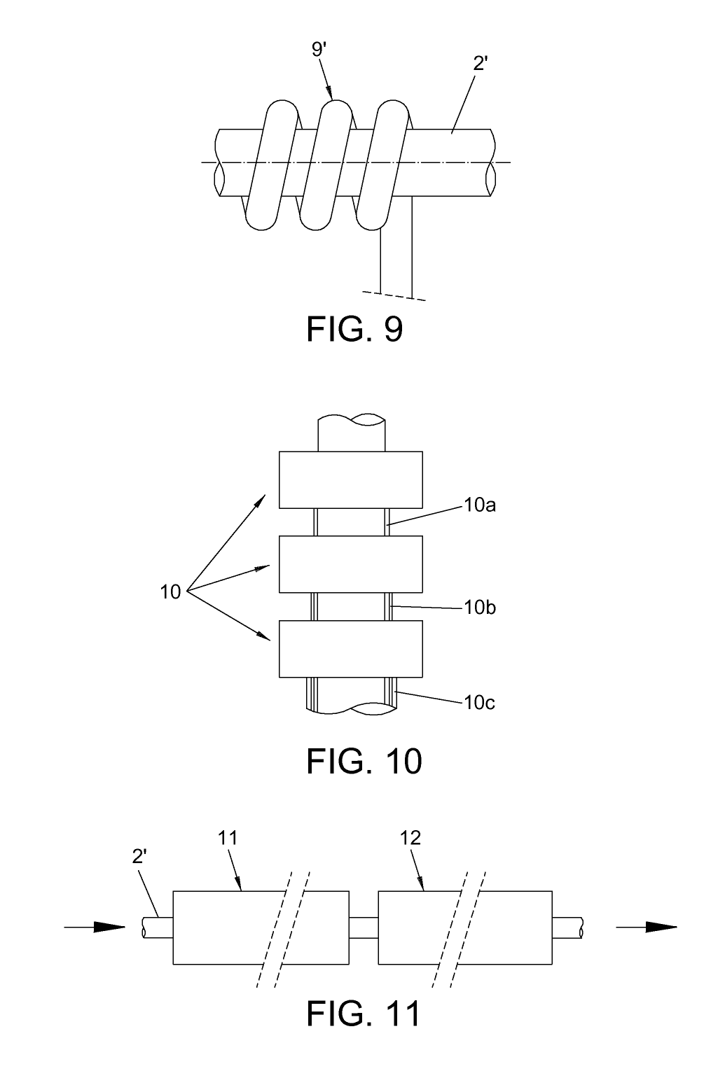

In a following step (FIG. 9), the metal tube 2′ is heated by means of a second induction device 9′ up to a temperature delimited between 125 and 150° C., prior to the application of the first layer of adhesive 10a materialized by a glue material. This heating step is very important, given that in the absence thereof, the glue material forming the first layer 10a, which is also applied while hot, would not be correctly adhered to the metal tube 2′.

In another subsequent step, as shown in FIG. 10, the following is applied by means of a co-extrusion device 10:
The first layer 10a of hot glue, between 225 and 230° C.
The second layer 10b of polypropylene material at around 225° C. with a fluidity comprised between 4 and 9 degrees, and preferably between 5 and 8 degrees.
The third layer 10c of polypropylene, at a temperature similar to the temperature of the second layer 10b, but with a fluidity of at least 45 degrees. In a preferred embodiment, the fluidity is comprised between 55 and 65 degrees.

During the application of the three layers, first 10a, second 10b, and third 10c, the hot temperature of the metal tube 2′ is maintained without any intermediate cooling.

The third layer 10c shows the finish of the set of the handle 1, said third layer 10c presenting a brighter aesthetic finish for having been worked at higher fluidity levels than the second layer 10b.

Finally, the metal tube 2′ coated with the three layers 10a, 10b and 10c, goes through two final steps: one prior step where the set of the handle 1 is placed in a first cooling pond 11 at a room temperature comprised between 20 and 30° C., and a subsequent step where the handle is placed in a second cooling pond 12, where a more aggressive cooling is applied using a cooling liquid at a temperature between 10 and 14° C.

These two last steps ensure the thermal stabilization of the three coating layers 10a, 10b and 10c, applied to the metal tube 2′, avoiding deformations and/or surface tensions.

In an embodiment of the invention, the handle obtained comprises the metal tube 2′, the first layer 10a of glue, the second layer 10b of white plastic, and the third layer 10c of a color other than white, such as red, for example.

1. Method for manufacturing handles for cleaning utensils, wherein the method comprises the following steps:
cleaning at least one outer face (3) of a metal strip (2) applying a degreasing product, eliminating the traces of cutting and coolant fluid and industrial oils inherent to the cutting and manufacturing processes of the metal strip (2);
brushing the outer face (3) of the metal strip (2) to eliminate residue and condition its surface to achieve a better adhesion;
deforming the metal strip (2) to form an open tubular structure with two facing longitudinal edges (6) close to each other;
heating the longitudinal edges (6) of the open tubular structure of the metal strip (2) up to a welding temperature;
closing the open tubular structure of the metal strip (2) completely until the longitudinal edges (6) touch each other, maintaining the welding temperature; in this step a metal tube (2′) is formed when the two longitudinal edges (6) are attached by means of a welding generatrix (6′);
eliminating irregularities in the metal tube (2′) by means of a smoothing, grinding and hardening process;
eliminating impurities, such as grease and slag, in the metal tube (2′) coming from the welding process;
heating the metal tube (2′) up to a temperature delimited between 125 and 150° C.;
applying a first layer (10a) of adhesive on the outer face of the metal tube (2′) at a hot temperature delimited between 225 and 230° C.;
applying a second layer (10b) of plastic material on the first layer (10a), also at a hot temperature delimited between 200 and 250° C.;
applying a third layer (10c) of plastic material on the second layer (10b) with a hot temperature between 200 and 250° C.; where the fluidity of this third layer (10c) is greater than the fluidity of the second layer.
cooling the set of the metal tube (2′) with the first layer (10a), second layer (10b) and third layer (10c) in a first cooling pond (11);
cooling the set of the metal tube (2′) with its three layers (10a, 10b, 10c) in a second cooling pond (12) after being in the first cooling pond (11); the temperature of the second cooling pond (12) being lower than the temperature of the first cooling pond (11).

2. Method for manufacturing handles for cleaning utensils according to claim 1, wherein the brushing of the outer face (3) of the metal strip (2) is carried out by means of a brushing device (5) integrating rotating brushes.

3. Method for manufacturing handles for cleaning utensils according to claim 1, wherein the deformation of the metal strip (2) is carried out by means of a first rotating roller device (13).

4. Method for manufacturing handles for cleaning utensils according to claim 1, wherein the longitudinal edges (6) of the open tubular structure forming the metal tube (2′), said longitudinal edges (6) are heated by means of a first induction device (9).

5. Method for manufacturing handles for cleaning utensils according to claim 1, wherein the formation of the metal tube (2′) is completed by means of a second rotating roller device (13′).

6. Method for manufacturing handles for cleaning utensils according to claim 1, wherein the elimination of the irregularities of the metal tube (2′) is carried out by means of laminating rollers for forming (7) and by means of laminating rollers for hardening and alignment (8).

7. Method for manufacturing handles for cleaning utensils according to claim 1, wherein the metal tube (2′) is heated by means of a second induction device (9′).

8. Method for manufacturing handles for cleaning utensils according to claim 1, wherein the first layer (10a) is a glue material.

9. Method for manufacturing handles for cleaning utensils according to claim 1, wherein the fluidity of the second layer (10b) of plastic material is delimited between 5 and 8 degrees.

10. Method for manufacturing handles for cleaning utensils according to claim 1, wherein the fluidity of the third layer (10c) of plastic material is delimited between 55 and 65 degrees.

11. Method for manufacturing handles for cleaning utensils according to claim 1, wherein the cooling temperature of the metal tube (2′) inside the first pond (11) is delimited between 20 and 30° C.

12. Method for manufacturing handles for cleaning utensils according to claim 1, wherein the cooling temperature of the metal tube (2′) inside the second pond (12) is delimited between 10 and 14° C.

13. Method for manufacturing handles for cleaning utensils according to claim 1, wherein it comprises an intermediate step applied after the formation of the metal tube (2′), which verifies the correct surface and structural finish of said metal tube.

14. Method for manufacturing handles for cleaning utensils according to claim 1, wherein the first layer (10a) the second layer (10b) and the third layer (10c) are applied by means of a co-extrusion device (10) wherein a inner space through which the metal tube (2′) advances is defined, the aforementioned layers (10a, 10b, 10c) being applied during the advance thereof.

15. Method for manufacturing handles for cleaning utensils according to claim 1, wherein the second layer (10b) and the third layer (10c) comprise a polypropylene plastic material.

16. Method for manufacturing handles for cleaning utensils according to claim 1, wherein the elimination of impurities of the metal tube (2′) is carried out by means of mechanical and friction processes.

17. Method for manufacturing handles for cleaning utensils according to claim 13, wherein the surface finish and structural finish of the metal tube (2′) is verified by means of artificial vision devices.
